(19) United States
(12) Patent Application Publication
(10) Pub. No.: US 2025/0342771 A1
(43) Pub. Date: Nov. 6, 2025

(54) INTEGRATED RUNWAY SAFETY ALERTING

(71) Applicant: Honeywell International Inc., Charlotte, NC (US)

(72) Inventors: Thea Feyereisen, Hudson, WI (US); Gang He, Morristown, NJ (US); Martin Puskar, Jesenice (CZ); Yasuo Ishihara, Peoria, AZ (US)

(73) Assignee: Honeywell International Inc., Charlotte, NC (US)

(21) Appl. No.: 18/656,417

(22) Filed: May 6, 2024

(51) Int. Cl. G08G 5/04; G08G 5/00

(52) U.S. Cl. CPC G08G 5/80; G08G 5/21; G08G 5/723; G08G 5/74; G08G 5/76

(57) ABSTRACT

An integrated runway safety system installed on an aerial vehicle is configured to analyze airport traffic data, airport safety data, and one or more parameters of the aerial vehicle in a combined context of runway geometry of a runway selected by the aerial vehicle. The integrated runway safety system can generate alerts, as well as prioritize and override alerts generated from other systems when the aerial vehicle is approaching or on a runway. The alerts processed by the integrated runway safety system are broadcasted to personnel onboard the aerial vehicle based on the priority associated with the alert.

### BACKGROUND

Runway incursions pose a grave threat to pilots and passengers. Such incursions happen when an aircraft and other vehicles or obstacles are improperly present on a runway at the wrong time. In one of the most deadliest incursions in aviation history, two aircraft in 1977 collided with each other on a Tenerife island runway, killing all 583 passengers and crew onboard both aircraft. Since this accident, aircraft are typically equipped with a ground proximity system that can detect the presence of obstacles and issue threat alerts to the crew.

The problem with conventional ground proximity systems is that these systems are self-contained within the aircraft and generate alerts independently of other systems on the aircraft. As a result, an aircraft may get many different types of alerts during ordinary navigation, each having different priorities to the pilot, but a high priority runway alert may not get a pilot's attention when it is buried with alerts generated by other systems.

### SUMMARY

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments.

In one embodiment, a system is disclosed. The system comprises a runway safety system coupled to an aerial vehicle. The runway safety system comprises at least one receiver. The at least one receiver is configured to receive: airport traffic data on (1) vehicles present on an airport or (2) vehicles scheduled to arrive and/or leave the airport, airport safety data on one or more safety conditions of the airport, wherein the airport safety data comprises airport environment data validated from one or more sources, and one or more parameters of the aerial vehicle. The system comprises at least one processor coupled to the at least one receiver. The at least one processor is configured to analyze the airport traffic data, airport safety data, and the one or more parameters in a combined context, and to generate a runway safety alert based on an analysis of the airport traffic data, airport safety data, and the one or more parameters. The at least one processor is configured to assign a priority level to the runway safety alert based on one or more priority criteria. The at least one processor is configured to prioritize the runway safety alert over one or more additional alerts acquired by the aerial vehicle. The at least one processor sends a control signal configured to broadcast the runway safety alert over one or more avionics devices on the aerial vehicle. Based on the priority level of the runway safety alert, the runway safety alert is broadcasted instead of the one or more additional alerts having a lower priority level.

In another embodiment, an integrated runway safety system is disclosed. The integrated runway safety system comprises at least one receiver. The at least one receiver is configured to receive: airport traffic data on (1) vehicles present on an airport or (2) vehicles scheduled to arrive and/or leave the airport, airport safety data on one or more safety conditions of the airport, wherein the airport safety data comprises airport environment data validated from one or more sources, and one or more parameters of an aerial vehicle. The integrated runway safety system comprises at least one processor coupled to the at least one receiver. The at least one processor is configured to analyze the airport traffic data, airport safety data, and the one or more vehicle parameters in a combined context, and to generate a runway safety alert based on an analysis of the airport traffic data, airport safety data, and the one or more parameters. The at least one processor is configured to assign a priority level to the runway safety alert based on one or more priority criteria. The at least one processor is configured to prioritize the runway safety alert over one or more additional alerts acquired by the aerial vehicle. The at least one processor sends a control signal configured to broadcast the runway safety alert over one or more avionics devices on the aerial vehicle. Based on the priority level of the runway safety alert, the runway safety alert is broadcasted instead of the one or more additional alerts having a lower priority level.

In yet another embodiment, a method of generating runway safety alerts is disclosed. The method comprises receiving airport traffic data of an airport, airport safety data of the airport, and one or more parameters of an aerial vehicle approaching or on a runway of the airport. The method comprises analyzing the airport traffic data, the airport safety data, and the one or more parameters in a combined context of a geometry of the runway. The method comprises generating a runway safety alert based on the analysis of the airport traffic data, the airport safety data, and the one or more parameters in the combined context of the geometry of the runway. The method comprises assigning a priority level to the runway safety alert. The method comprises broadcasting the runway safety alert to one or more avionics devices on an aerial vehicle.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, as briefly described as follows.

FIG. 1 depicts a block diagram of an integrated runway safety system, as described in one or more embodiments.

FIGS. 2A-2B depict block diagrams of integrated runway safety systems set in different operation states, as described in one or more embodiments.

FIG. 3 depicts a block diagram of a system for generating prioritized aircraft alerts, as described in one or more embodiments.

FIG. 4 depicts a flow diagram of a method for generating prioritized aircraft alerts, as described in one or more embodiments.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, any methods presented in the drawing figures and the specification are not to be construed as limiting the order in which the individual steps may be performed. The following detailed description is, therefore, not to be taken in a limiting sense.

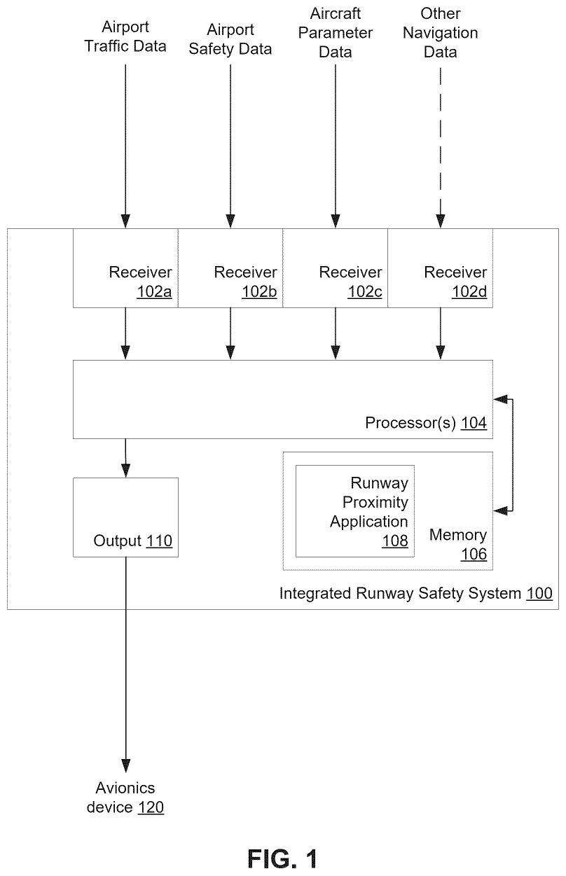

FIG. 1 depicts a block diagram of an integrated runway safety system 100 in which the concepts of the subject disclosure can be implemented in. Although not explicitly shown in FIG. 1, the integrated runway safety system 100 is coupled to an aerial vehicle such as an aircraft. Use of the term “aerial vehicle” is not intended to be limiting and includes all classes of aerial vehicles falling within the ordinary meaning of the term. Throughout the disclosure, the aerial vehicle may be further illustrated as a commercial aircraft with the understanding that the principles described herein apply to other vehicles where applicable.

Also, in various embodiments the integrated runway safety system 100 can be implemented as an independent system that is installed on the aerial vehicle, or can be combined functionally with one or more existing systems on the aerial vehicle. For example, the integrated runway safety system 100 can be implemented as part of a ground proximity warning system (GPWS) (including an enhanced ground proximity warning system (EGPWS), traffic collision and avoidance system (TCAS), terrain avoidance system, or with other navigation systems used by the aerial vehicle. For purposes of this disclosure, the integrated runway safety system 100 is pedagogically described as a standalone system.

Integrated runway safety system 100 includes at least one receiver 102, of which four receivers 102a-d are shown in FIG. 1, and at least one processor 104 that receives data from each of the receivers 102a-d. The data received by each receiver 102a-d can be received from other systems on the aircraft, and/or can be acquired from sources outside of the aircraft, such as from external databases, base station entities, etc. Receiver 102a receives airport traffic data on vehicles that are or will be arriving or leaving an airport runway. Such data can be acquired from one or more automatic dependent surveillance broadcast (ADS-B) transmitters within range of the aerial vehicle. ADS-B data includes information about identities, position, and other navigation parameters about other aircraft within a range of to the position of the ownship aircraft. The airport traffic data enables the ownship aircraft (that is, the aircraft installed with the integrated runway safety system 100) to be aware of other aircraft that are arriving, present, or leaving a runway.

Additionally, receiver 102b receives airport safety data from one or more sources. The airport safety data details one or more safety conditions of the airport that the ownship aircraft is entering or leaving. Such data can include weather data (for example, wind velocity, humidity, icing conditions, etc.), known obstacles present on the airport and/or runways, runway surface conditions, and airport environment data, which can be validated from one or more sources. Additionally, the airport safety data includes the physical geometry layout of the runway that the aircraft is approaching. For example, systems such as an EGPWS can provide geometric models of the runway surface as represented as a map. The geometry models include accurate information of runway positions, elevations, width, and length. In other cases, geometry models may further include information such as taxiways, hold short positions, etc. Intruders and obstacles present on the runway such as other vehicles and personnel can be identified from the map geometry with intruder position and movement information and can be indicative of potential alarm in approaching the runway. Additionally, environmental data and any identified safety conditions can be processed in conjunction with the physical geometry of the runway to identify potential sources of alarms.

In conjunction with the airport traffic data and the airport safety data, integrated runway safety system 100 also receives aircraft parameter data at receiver 102c. Aircraft parameter data includes data on one or more parameters of the ownship aircraft, such as position, velocity, acceleration, angle-of-sideslip, angle-of-attack, and other parameters used in navigation. Such data can originate from sensor systems onboard the aircraft, for example, from an attitude and heading reference system (ARHS), inertial navigation system (INS), and other systems. Optionally, integrated runway safety system 100 receives other navigation data at receiver 102d. Such data can include any data used by the ownship aircraft not already specified.

Integrated runway safety system 100 also comprises one or more processors 104 that receive each of the data sets from receivers 102a-d. Processor 104 is configured to analyze the received data sets and determine whether there is a risk, hazard, and/or threat posed to the ownship aircraft in utilizing a runway selected by the aircraft for landing, takeoff, or crossing during aircraft movement within an airport environment. If such a risk, hazard, or threat exists, processor 104 is configured to generate an alert indicative of the type of risk, hazard, or threat identified with the runway. For example, processor 104 can execute a runway proximity application 108 stored in memory 106 to identify potential risks, hazards, and/or threats with a runway that the ownship aircraft is approaching. In a specific example of the runway safety analysis conducted by processor 104, if processor 104 determines that another aircraft is present on the runway or is scheduled to takeoff on the same runway that the ownship aircraft is approaching, it can generate a prioritized alert to the pilot and/or crew that the selected runway may not be suitable for use. Any data generated by processor 104 can be stored in memory 106, and any data received from receivers 102a-d can be stored in memory 106 or accessed via one or more databases in memory 106.

Unlike conventional runway safety systems, integrated runway safety system 100 is configured to analyze data received from multiple sources both intrinsic and extrinsic to the ownship aircraft in a common processing context. That is, instead of having each system review data independently in isolation, integrated runway safety system 100 evaluates the airport traffic data, airport safety data, and aircraft parameter data holistically in an integrated fashion through a common geometry context. Doing so provides a more robust means of processing data in the context of runway safety navigation, in which situational awareness becomes much more important for pilots and crew.

Additionally, in some embodiments integrated runway safety system 100 acts as a centralized alerting system that can generate prioritized alerts and prioritize alerts from other systems when the ownship aircraft is approaching a runway. For example, when processor 104 determines a risk, hazard, and/or threat, it can generate an alert and assign a priority to the alert based on the severity of the risk, hazard, and/or threat as reflected in the received data. In most cases, the risk, hazard, and/or threat identified in the context of runway safety will be assigned a high priority level since the ownship aircraft has selected the runway for imminent landing or takeoff. For example, an alert generated based on icing conditions present on the runway (for example, accumulated snowfall or ice on the surface of the runway as reflected in the runway geometry or weather reports) would likely be assigned high to highest priority by processor 104 since it can result in imminent danger to the aircraft. Other alerts, such as a fog advisory or a delayed arrival of another aircraft, may be given lower priority by processor 104 since they may indicate complications in using a selected runway. Each alert can also be uniquely associated with a specific runway, so that if another runway is selected, the alert may be removed or replaced with different alerts unique to that runway geometry.

For any other systems that generate alerts to the pilot, or any alerts received external to the ownship aircraft (such as communication alerts from ground stations), integrated runway safety system 100 can prioritize alerts so that the pilot can focus their attention on the most important alerts when approaching a runway. For example, if a first sensor system onboard the aircraft generates an alert that the fuel supply is running low, a second sensor system onboard the aircraft generates an alert that a fault has occurred in one of multiple particle detection systems, and an alert generated by processor 104 indicates personnel is located on a selected runway, processor 104 prioritizes the alerts so that the runway safety alert is highest in priority, followed by the low fuel supply alert, and with the fault alert having lowest priority. In this scenario, the priority assignment is selected since the ownship aircraft is approaching the selected runway (in this particular scenario, the aircraft is landing). A low fuel supply in most circumstances, while important, is not as high in priority since the aircraft will be landing soon. And finally, a fault from a redundant particle detection system is given low priority because other particle detection systems may be used in its place. In other navigation contexts, i.e. when the aircraft is in mid-flight, the priority assignment will likely change. In another example, if the ownship aircraft lands on a runway with excessive momentum (that is, it is about to overrun the runway with insufficient maneuvering space) and another vehicle enters the runway (triggering a traffic alert), the integrated runway safety system 100 may determine or receive the following alerts: (1) excessive landing speed; (2) insufficient feet remaining on the runway for projected landing termination; (3) traffic alert describing additional vehicle on runway, the integrated runway safety system 100 will prioritize these alerts based on the severity of the risks associated with each alert. In one embodiment, integrated runway safety system 100 first broadcasts alert (1) (e.g., in the form “MAX BRAKES, MAX REVERSE”) when the excessive speed of the ownship aircraft presents the highest risk for danger. As the ownship aircraft attempts to avoid danger and the risk associated with alert (1) decreases in severity, then integrated runway safety system 100 evaluates each alert in the common geometry of the runway and may broadcast either alert (2) or (3) if that alert is higher in severity.

In some embodiments, and as described in more detail with respect to the following figures, the analysis of risks and/or faults and prioritization of alerts by processor 104 only occurs in the context of runway safety navigation, so that when the ownship aircraft leaves a runway, other systems on the aircraft function independently and integrated runway safety system 100 enters an inactive state. When implemented, the prioritization of alerts generated by other systems can be evaluated based on one or more priority criteria (which can be stored in memory 106), such as the severity of the risk and/or hazard associated with the alert, the type of system generating the alert, the distance the ownship aircraft is to a selected runway, and the time in which the alert was generated. When prioritizing an alert, processor 104 causes the alert with the highest priority (such as the runway safety alert) to be broadcasted to the pilot and/or crew right away, so that other lower priority alerts are delayed. That is, processor 104 can override the alerts generated by other systems so that the alert generated by processor 104 with the highest priority is broadcasted instead of other pending alerts.

Still referring to FIG. 1, processing 104 communicates the alert to output 110 of integrated runway safety system 100. Output 110 then broadcasts the alert to one or more avionics devices 120 on the ownship aircraft. For example, integrated runway safety system 100 can be coupled to aural, visual, or vibrational devices located in the cockpit and/or the personnel area of the aircraft. Accordingly, the alert can be broadcasted in an aural form (siren, distinctive tone, etc.), visual form (textual, graphical, or photographic), or vibrational. In some embodiments, integrated runway safety system 100 is generated to offboard devices (devices that are not physically installed on the aircraft but used by the pilot or crew during navigation). Such offboard devices include tablets, smartphones, and laptops equipped with aircraft navigation functionality. In this way, the crew can be alerted without being physically proximate to an installed cockpit system. Avionics device 120 can also include an onboard device that is installed on the aircraft equipped with a display or audio functionality to broadcast alerts.

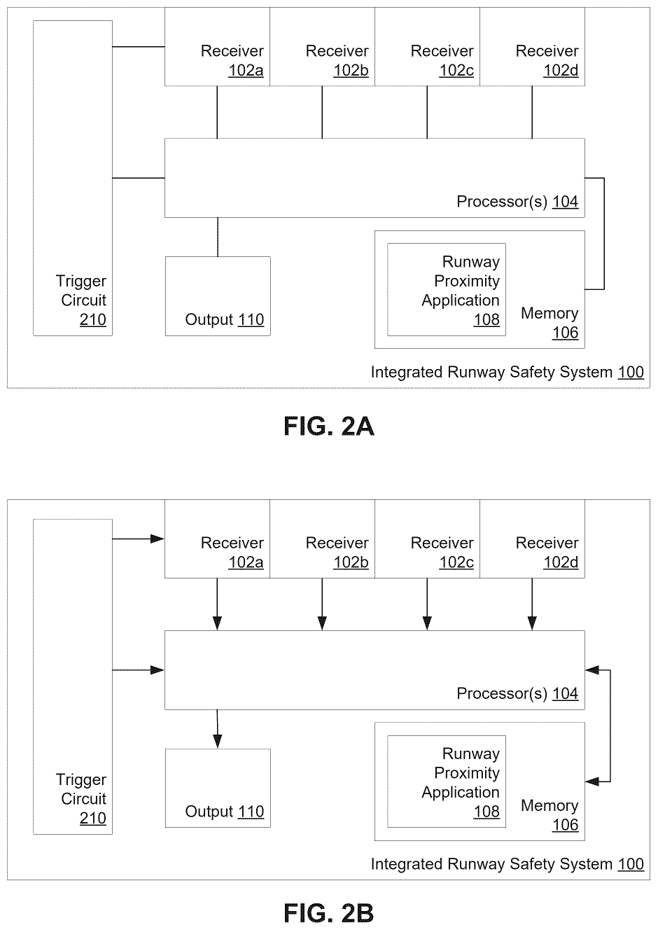

FIGS. 2A-2B depict block diagrams of an integrated runway safety system 100 set in different operation states. Specifically, FIG. 2A depicts integrated runway safety system 100 in an inactive state, while FIG. 2B depicts integrated runway safety system 100 in an active state. To denote the operation as an active state, arrows are shown in FIG. 2B to communicate the flow of information or signals in the integrated runway safety system 100. In contrast, the absence of information or signals is denoted in FIG. 2A by connecting lines to indicate that the integrated runway safety system 100 is inactive.

As previously noted, integrated runway safety system 100 only operates to integrate data sources from other systems and prioritize alerts generated by other systems (including overriding alerts) when the ownship aircraft is approaching a selected runway. When the ownship aircraft is not approaching a runway, as in the case of general enroute navigation to a destination, integrated runway safety system 100 operates as shown in FIG. 2A, in which integrated runway safety system 100 is inactive. In this state, processor 104 may undergo basic processing functions and status reporting, but does not analyze any data or generate any alerts related to a runway environment. Once the aircraft selects a runway and begins landing, takeoff procedures, or movement within an airport environment, integrated runway safety system 100 becomes active and performs the functions described with respect to FIG. 1.

The change in the operational state of integrated runway safety system 100 is set by a trigger circuit 210 coupled to processor 104 and each of the receivers 102a-d. In some embodiments, trigger circuit 210 is configured to send control signals to processor 104 and receivers 102a-d that activate these components. Once activated, receivers 102a-d receive data from other sources, and processor 104 begins analyzing data to identify risks, hazards, and/or threats as well as to generate and prioritize alerts, as described with respect to FIG. 1. When the aircraft is departing from a selected runway, either because the aircraft has finished landing or taken off from the runway, trigger circuit 210 deactivates processor 104 and receivers 102a since runway safety analysis is no longer needed. In some embodiments, trigger circuit 210 includes one or more switches and one or more processors that execute the triggering functions.

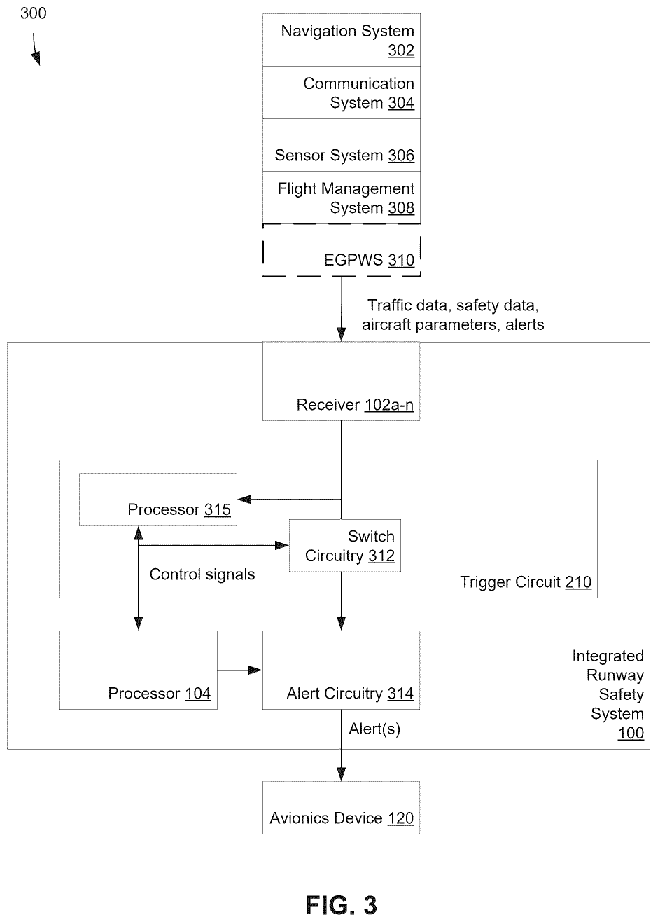

FIG. 3 depicts a block diagram of a system 300 for generating prioritized aircraft alerts. System 300 can be implemented with the integrated runway safety system 100 described in the context of FIGS. 1-2. In FIG. 3, system 300 includes multiple aircraft systems that are coupled to integrated runway safety system 100. For example, system 300 includes navigation system 302, communication system 304, sensor system 306, flight management system 308, and optionally EGPWS 310 coupled to receivers 102a-n, though other systems can be used. Integrated runway safety system 100 is also coupled to one or more avionics devices 120. Each avionics device 120 is configured to display data or alerts to the personnel onboard the aircraft in a textual, visual, and/or vibrational format. Examples of avionics devices include a navigational display device, a primary flight display, and a Maintenance Terminal.

Navigation system 302 is configured to provide navigation data (indicative of aircraft parameters) to integrated runway safety system 100, and is implemented as an AHRS or an INS, for example. Communication system 304 is configured to provide information from messages (indicative of traffic data or airport safety data) exchanged between the ownship aircraft and other aircraft or ground systems. Communication system 304 for example is a radio system that can establish radio communications via one or more communication links. Sensor system 306 (for example, a particle detection system or radar altimeter) is configured to provide sensory information associated with the ownship aircraft (indicative of aircraft parameters). Flight management system 308 is configured to provide one or more of traffic data, airport safety data, and vehicle parameters to the integrated runway safety system 100. And optionally, an EGPWS 310 is coupled to the integrated runway safety system 100 and is configured to provide the runway geometry and safety conditions of the selected runway. As previously noted, in some embodiments integrated runway safety system 100 is implemented as part of an EGPWS 310.

The data received by receivers 102a-n are provided to trigger circuit 210. Trigger circuit 210 is configured to determine whether the ownship aircraft is approaching a runway. As shown in FIG. 3, trigger circuit 210 comprises one or more processors 315 coupled to switch circuitry 312. When the aircraft is enroute to a destination and not near a landing site, integrated runway safety system 100 is set in an inactive state, in which the data from navigation system 302, communication system 304, sensor system 306, flight management system 308, and EGPWS 310 are provided by the integrated runway safety system 100 to avionics device 120. In this inactive configuration processor 315 sets the switch circuitry 312 to electrically couple receivers 102a-n to alert circuitry 314. While in this configuration all data and alerts generated by navigation system 302, communication system 304, sensor system 306, flight management system 308, and EGPWS 310 can pass through directly to alert circuitry 314. Processor 315 also concurrently monitors the data received by these systems to determine if the ownship aircraft has selected a runway and is approaching the selected runway.

Once processor 315 determines that the ownship aircraft is approaching a selected runway, it sends control signals to switch circuitry 312 that closes the circuit between receivers 102a-n and alert circuitry 314. This prevents data and alerts generated from navigation system 302, communication system 304, sensor system 306, flight management system 308, and EGPWS 310 to be directly received by the intended avionics device 120. Instead, processor 315 provides the data and alerts received from these systems to processor 104. Based on the traffic data, airport safety data, and the aircraft parameters received at receivers 102a-n, processor 104 determines whether there are any risks, hazards, and/or threats associated with the selected runway. If so, processor 104 directs alert circuitry 314 to generate an appropriate alert that is broadcasted to one or more of the avionics devices 120.

If one or more of the data received from navigation system 302, communication system 304, sensor system 306, flight management system 308, and EGPWS 310 include an alert associated with one of these systems, then processor 104 prioritizes the alerts generated by these systems in addition to any alerts associated with the selected runway that the ownship aircraft is approaching. That is, instead of each system sending its alert separately to avionics device 120, when integrated runway safety system 100 is active processor 104 assigns priority levels to each received alert, along with any alerts associated with the selected runway, and selects the alerts to broadcast based on the priority level associated with the alert. For example, when one or more of navigation system 302, communication system 304, sensor system 306, flight management system 308, and EGPWS 310 generate an alert, processor 104 prioritizes the alerts in the context of runway safety operations or protocols needed to be performed by the ownship aircraft in order to land or depart from the selected runway safely. If there are no conflicts with any runway safety operations, processor 104 controls alert circuitry 314 to generate the appropriate alert for each received alert. If any such conflicts arise, processor 104 prioritizes each alert appropriately and controls alert circuitry 314 to generate each alert based on assigned priority.

In some embodiments, processor 104 subsequently identifies one or more risks hazards, and/or threats associated with the selected runway as processor 104 receives alerts from other systems. If processor 104 later determines that an alert should be issued associated with the selected runway, it prioritizes the runway safety alert in the context of other received alerts. In many situations a runway safety alert will be given highest priority when integrated runway safety system 100 is active since the ownship aircraft will be imminently approaching a runway; hence a runway safety alert in these situations will be generated and displayed first to avionics device 120, and may also override any currently displayed alerts received from other systems.

Once the ownship aircraft is no longer approaching a selected runway, processor 315 deactivates integrated runway safety system 100 by reconfiguring switch circuitry 312, thereby enabling navigation system 302, communication system 304, sensor system 306, flight management system 308, and EGPWS 310 to send data and alerts to avionics device 120 normally without further analysis by processor 104. Processor 315 then continues to monitor data received by these systems to determine whether the ownship aircraft is approaching a runway.

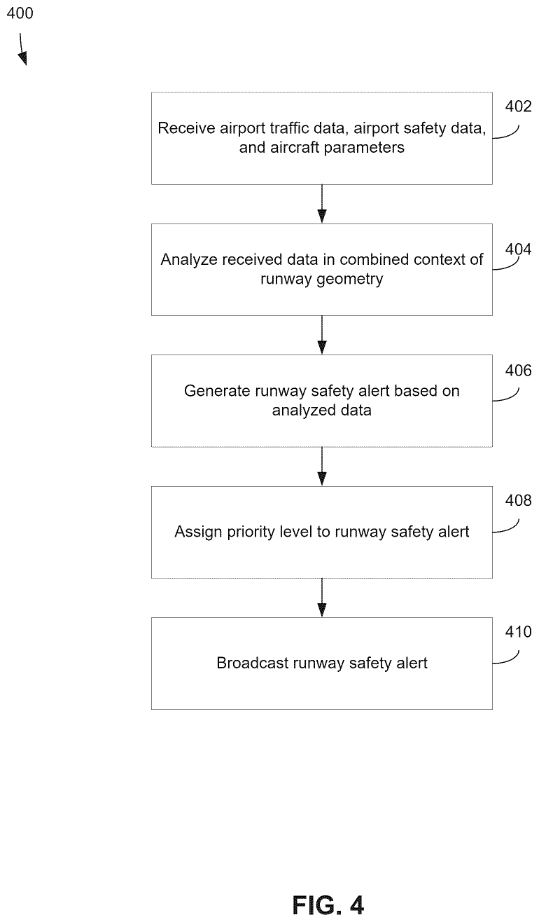

FIG. 4 depicts a flow diagram of a method 400 for generating prioritized aircraft alerts. Method 400 may be implemented via the techniques described with respect to FIGS. 1-3, but may be implemented via other techniques as well. The blocks of the flow diagram have been arranged in a generally sequential manner for ease of explanation; however, it is to be understood that this arrangement is merely exemplary, and it should be recognized that the processing associated with the methods described herein (and the blocks shown in the Figures) may occur in a different order (for example, where at least some of the processing associated with the blocks is performed in parallel and/or in an event-driven manner).

Method 400 includes receiving airport traffic data, airport safety data, and one or more aircraft parameters at block 402. The airport traffic data describes the vehicles that are present on the airport or scheduled to leave and/or arrive at an airport that the ownship aircraft is approaching or on. The airport safety data describes any safety conditions present for one or more runways at the airport, including inclement weather, runway anomalies, extent of runway remaining (during landing and takeoff), and any known obstacles present on the runway. In some embodiments, the airport safety data includes a physical geometry of one or more runways at the airport, which can be depicted as a map. Airport safety data can also include airport environmental data validated from one or more sources. Aircraft parameters include any parameters that describe the present state of the ownship aircraft, as received from one or more systems on the aircraft.

Proceeding to block 404, method 400 analyzes the data received at block 402 in the combined context of the runway geometry. Here, all the airport traffic data, airport safety data, and aircraft parameters are processed together to determine whether there are any risks and/or hazards associated with one or more runways of the airport relative to the ownship aircraft. For example, data originating from another system such as atmospheric particle data from a particle detection sensor onboard the aircraft is processed in the context of the runway geometry to determine whether the particle data indicates any risk and/or hazard in utilizing the selected runway.

At block 406, method 400 generates a runway threat alert based on the analyzed data. That is, method 400 determines that a risk, hazard, and/or threat is present for the selected runway utilizing a combination of data from multiple sources, including the airport traffic data, airport safety data, and aircraft parameters, and does so in the context of the runway geometry for the selected runway. The runway threat alert is given a priority level at block 408 whose priority depends on the nature of the risk, hazard, and/or threat identified. For immediate substantial threats to the safety of the ownship aircraft, the runway threat alert is assigned very high priority, while advisories and potential risks are assigned lower priority. For any other system alerts received in conjunction with the runway safety alert determined at block 408, the runway alert is prioritized with the other system alerts. In many cases, the runway safety alert will have highest or high priority over another system alert since the ownship aircraft is approaching a runway.

Method 400 follows with broadcasting the runway threat alert at block 410. For a runway safety alert with higher priority over another system alert, method 400 broadcasts the runway safety alert instead of the system alert, at least for a designated time period. If another system alert is already broadcasted, method 400 can override the system alert with the runway safety alert. The runway safety alert can be broadcasted in a visual, aural, and/or vibrational manner to one or more avionics devices installed or associated with the ownship aircraft.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), electrically-erasable programmable read-only memory (EEPROM), and flash memory devices; magnetic disks such as internal hard disks and removable disks; magneto-optical disks; and the like. Any of the foregoing may be supplemented by, or incorporated in, specially-designed application specific integrated circuits (ASICs).

### Example Embodiments

Example 1 includes a system, comprising: a runway safety system coupled to an aerial vehicle, wherein the runway safety system comprises: at least one receiver, wherein the at least one receiver is configured to receive: airport traffic data on (1) vehicles present on an airport or (2) vehicles scheduled to arrive and/or leave the airport, airport safety data on one or more safety conditions of the airport, wherein the airport safety data comprises airport environment data validated from one or more sources, and one or more parameters of the aerial vehicle; and at least one processor coupled to the at least one receiver, wherein the at least one processor is configured to analyze the airport traffic data, airport safety data, and the one or more parameters in a combined context, and to generate a runway safety alert based on an analysis of the airport traffic data, airport safety data, and the one or more parameters, wherein the at least one processor is configured to assign a priority level to the runway safety alert based on one or more priority criteria, wherein the at least one processor is configured to prioritize the runway safety alert over one or more additional alerts acquired by the aerial vehicle, wherein the at least one processor sends a control signal configured to broadcast the runway safety alert over one or more avionics devices on the aerial vehicle, wherein based on the priority level of the runway safety alert, the runway safety alert is broadcasted instead of the one or more additional alerts having a lower priority level.

Example 2 includes the system of Example 1, wherein the airport safety data includes geometry of a runway of the airport and/or one or more weather conditions associated with the airport.

Example 3 includes the system of any of Examples 1-2, wherein the runway safety system comprises a ground proximity warning system (GPWS), enhanced ground proximity warning system (EGPWS), traffic collision and avoidance system (TCAS), or terrain avoidance system.

Example 4 includes the system of any of Examples 1-3, comprising one or more additional systems coupled to the runway safety system, wherein the runway safety system is configured to receive data and/or alerts generated by the one or more additional systems.

Example 5 includes the system of Example 4, wherein the runway safety system comprises a trigger circuit, wherein the trigger circuit is configured to set the runway safety system in an active operational state when the aerial vehicle is approaching or on or proximate to a selected runway, wherein the trigger circuit is configured to set the runway safety system in an inactive operational state when the aerial vehicle is not approaching a selected runway.

Example 6 includes the system of Example 5, wherein in the inactive operational state, the runway safety system is configured to pass the data and/or alerts received from the one or more additional systems to the one or more avionics devices.

Example 7 includes the system of any of Examples 5-6, wherein in the inactive operational state, the trigger circuit is configured to determine whether the aerial vehicle is approaching the selected runway based on the data and/or alerts received from the one or more additional systems.

Example 8 includes the system of any of Examples 1-7, wherein the runway safety system is configured to broadcast the runway safety alert in a visual, audio, and/or vibrational format.

Example 9 includes an integrated runway safety system, comprising: at least one receiver, wherein the at least one receiver is configured to receive: airport traffic data on (1) vehicles present on an airport or (2) vehicles scheduled to arrive and/or leave the airport, airport safety data on one or more safety conditions of the airport, wherein the airport safety data comprises airport environment data validated from one or more sources, and one or more parameters of an aerial vehicle; and at least one processor coupled to the at least one receiver, wherein the at least one processor is configured to analyze the airport traffic data, airport safety data, and the one or more vehicle parameters in a combined context, and to generate a runway safety alert based on an analysis of the airport traffic data, airport safety data, and the one or more parameters, wherein the at least one processor is configured to assign a priority level to the runway safety alert based on one or more priority criteria, wherein the at least one processor is configured to prioritize the runway safety alert over one or more additional alerts acquired by the aerial vehicle, wherein the at least one processor sends a control signal configured to broadcast the runway safety alert over one or more avionics devices on the aerial vehicle, wherein based on the priority level of the runway safety alert, the runway safety alert is broadcasted instead of the one or more additional alerts having a lower priority level.

Example 10 includes the integrated runway safety system of Example 9, wherein the airport safety data includes geometry of a runway of the airport and/or one or more weather conditions associated with the airport.

Example 11 includes the integrated runway safety system of any of Examples 9-10, wherein the integrated runway safety system comprises a ground proximity warning system (GPWS), enhanced ground proximity warning system (EGPWS), traffic collision and avoidance system (TCAS), or terrain avoidance system.

Example 12 includes the integrated runway safety system of any of Examples 9-11, wherein the integrated runway safety system is coupled to an output of one or more additional systems, wherein the integrated runway safety system is configured to receive data and/or alerts generated by the one or more additional systems.

Example 13 includes the integrated runway safety system of Example 12, comprising: a trigger circuit, wherein the trigger circuit is configured to set the integrated runway safety system in an active operational state when the aerial vehicle is approaching a selected runway, wherein the trigger circuit is configured to set the integrated runway safety system in an inactive operational state when the aerial vehicle is not approaching a selected runway.

Example 14 includes the integrated runway safety system of Example 13, wherein in the inactive operational state, the integrated runway safety system is configured to pass the data and/or alerts received from the one or more additional systems to the one or more avionics devices.

Example 15 includes the integrated runway safety system of any of Examples 13-14, wherein in the inactive operational state, the trigger circuit is configured to determine whether the aerial vehicle is approaching the selected runway based on the data and/or alerts received from the one or more additional systems.

Example 16 includes the integrated runway safety system of any of Examples 9-15, wherein the integrated runway safety system is configured to broadcast the runway safety alert in a visual, audio, and/or vibrational format.

Example 17 includes a method of generating runway safety alerts, comprising: receiving airport traffic data of an airport, airport safety data of the airport, and one or more parameters of an aerial vehicle approaching or on a runway of the airport; analyzing the airport traffic data, the airport safety data, and the one or more parameters in a combined context of a geometry of the runway; generating a runway safety alert based on the analysis of the airport traffic data, the airport safety data, and the one or more parameters in the combined context of the geometry of the runway; assigning a priority level to the runway safety alert; and broadcasting the runway safety alert to one or more avionics devices on an aerial vehicle.

Example 18 includes the method of Example 17, comprising: determining that the priority level of the runway safety alert is higher than a priority level associated with another alert generated by a system on the aerial vehicle; and broadcasting the runway safety alert instead of the another alert to the one or more avionics devices.

Example 19 includes the method of any of Examples 17-18, comprising broadcasting the runway safety alert to the one or more avionics devices in a visual, audio, and/or vibrational format.

Example 20 includes the method of any of Examples 17-19, wherein the runway safety alert indicates one or more risks, hazards, and/or threats to the runway.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system, comprising:
a runway safety system coupled to an aerial vehicle, wherein the runway safety system comprises:
at least one receiver, wherein the at least one receiver is configured to receive:
airport traffic data on (1) vehicles present on an airport or (2) vehicles scheduled to arrive and/or leave the airport,
airport safety data on one or more safety conditions of the airport, wherein the airport safety data comprises airport environment data validated from one or more sources, and
one or more parameters of the aerial vehicle; and
at least one processor coupled to the at least one receiver, wherein the at least one processor is configured to analyze the airport traffic data, airport safety data, and the one or more parameters in a combined context, and to generate a runway safety alert based on an analysis of the airport traffic data, airport safety data, and the one or more parameters,
wherein the at least one processor is configured to assign a priority level to the runway safety alert based on one or more priority criteria, wherein the at least one processor is configured to prioritize the runway safety alert over one or more additional alerts acquired by the aerial vehicle,
wherein the at least one processor sends a control signal configured to broadcast the runway safety alert over one or more avionics devices on the aerial vehicle,
wherein based on the priority level of the runway safety alert, the runway safety alert is broadcasted instead of the one or more additional alerts having a lower priority level.

2. The system of claim 1, wherein the airport safety data includes geometry of a runway of the airport and/or one or more weather conditions associated with the airport.

3. The system of claim 1, wherein the runway safety system comprises a ground proximity warning system (GPWS), enhanced ground proximity warning system (EGPWS), traffic collision and avoidance system (TCAS), or terrain avoidance system.

4. The system of claim 1, comprising one or more additional systems coupled to the runway safety system, wherein the runway safety system is configured to receive data and/or alerts generated by the one or more additional systems.

5. The system of claim 4, wherein the runway safety system comprises a trigger circuit, wherein the trigger circuit is configured to set the runway safety system in an active operational state when the aerial vehicle is approaching or on or proximate to a selected runway, wherein the trigger circuit is configured to set the runway safety system in an inactive operational state when the aerial vehicle is not approaching a selected runway.

6. The system of claim 5, wherein in the inactive operational state, the runway safety system is configured to pass the data and/or alerts received from the one or more additional systems to the one or more avionics devices.

7. The system of claim 5, wherein in the inactive operational state, the trigger circuit is configured to determine whether the aerial vehicle is approaching the selected runway based on the data and/or alerts received from the one or more additional systems.

8. The system of claim 1, wherein the runway safety system is configured to broadcast the runway safety alert in a visual, audio, and/or vibrational format.

9. An integrated runway safety system, comprising:
at least one receiver, wherein the at least one receiver is configured to receive:
airport traffic data on (1) vehicles present on an airport or (2) vehicles scheduled to arrive and/or leave the airport,
airport safety data on one or more safety conditions of the airport, wherein the airport safety data comprises airport environment data validated from one or more sources, and
one or more parameters of an aerial vehicle; and
at least one processor coupled to the at least one receiver, wherein the at least one processor is configured to analyze the airport traffic data, airport safety data, and the one or more vehicle parameters in a combined context, and to generate a runway safety alert based on an analysis of the airport traffic data, airport safety data, and the one or more parameters,
wherein the at least one processor is configured to assign a priority level to the runway safety alert based on one or more priority criteria, wherein the at least one processor is configured to prioritize the runway safety alert over one or more additional alerts acquired by the aerial vehicle,
wherein the at least one processor sends a control signal configured to broadcast the runway safety alert over one or more avionics devices on the aerial vehicle,
wherein based on the priority level of the runway safety alert, the runway safety alert is broadcasted instead of the one or more additional alerts having a lower priority level.

10. The integrated runway safety system of claim 9, wherein the airport safety data includes geometry of a runway of the airport and/or one or more weather conditions associated with the airport.

11. The integrated runway safety system of claim 9, wherein the integrated runway safety system comprises a ground proximity warning system (GPWS), enhanced ground proximity warning system (EGPWS), traffic collision and avoidance system (TCAS), or terrain avoidance system.

12. The integrated runway safety system of claim 9, wherein the integrated runway safety system is coupled to an output of one or more additional systems, wherein the integrated runway safety system is configured to receive data and/or alerts generated by the one or more additional systems.

13. The integrated runway safety system of claim 12, comprising: a trigger circuit, wherein the trigger circuit is configured to set the integrated runway safety system in an active operational state when the aerial vehicle is approaching a selected runway, wherein the trigger circuit is configured to set the integrated runway safety system in an inactive operational state when the aerial vehicle is not approaching a selected runway.

14. The integrated runway safety system of claim 13, wherein in the inactive operational state, the integrated runway safety system is configured to pass the data and/or alerts received from the one or more additional systems to the one or more avionics devices.

15. The integrated runway safety system of claim 13, wherein in the inactive operational state, the trigger circuit is configured to determine whether the aerial vehicle is approaching the selected runway based on the data and/or alerts received from the one or more additional systems.

16. The integrated runway safety system of claim 9, wherein the integrated runway safety system is configured to broadcast the runway safety alert in a visual, audio, and/or vibrational format.

17. A method of generating runway safety alerts, comprising:
receiving airport traffic data of an airport, airport safety data of the airport, and one or more parameters of an aerial vehicle approaching or on a runway of the airport;
analyzing the airport traffic data, the airport safety data, and the one or more parameters in a combined context of a geometry of the runway;
generating a runway safety alert based on the analysis of the airport traffic data, the airport safety data, and the one or more parameters in the combined context of the geometry of the runway;
assigning a priority level to the runway safety alert; and
broadcasting the runway safety alert to one or more avionics devices on an aerial vehicle.

18. The method of claim 17, comprising:
determining that the priority level of the runway safety alert is higher than a priority level associated with another alert generated by a system on the aerial vehicle; and
broadcasting the runway safety alert instead of the another alert to the one or more avionics devices.

19. The method of claim 17, comprising broadcasting the runway safety alert to the one or more avionics devices in a visual, audio, and/or vibrational format.

20. The method of claim 17, wherein the runway safety alert indicates one or more risks, hazards, and/or threats to the runway.
